(19) United States
(12) Patent Application Publication
(10) Pub. No.: US 2008/0127119 A1
(43) Pub. Date: May 29, 2008

(54) Method and system for dynamic debugging of software

(76) Inventor: Bulent Kasman, Antioch, CA (US)

Correspondence Address: FAY KAPLUN & MARCIN, LLP, 150 BROADWAY, SUITE 702, NEW YORK, NY, 10038, US

(21) Appl. No.: 11/541,969

(22) Filed: Oct. 2, 2006

(51) Int. Cl. G06F 9/44

(52) U.S. Cl. 717/130

(57) ABSTRACT

A method for inserting a branch instruction at an instrumentation location within a running code on a target device, the branch instruction being used execute a separately compiled instrumentation code from the running user code, exposing at least one interface corresponding to at least one callable function, and connecting the separately compiled instrumentation code to the selected at least one interface, wherein the at least one callable function executes within the separately compiled instrumentation code. A debugging system having a plurality of callable functions, each callable function selectively exposing an interface, a receiving function receiving a call to one of the interfaces, wherein the call is received from a separately compiled instrumentation code being executed within a running user code a target device, and an output function receiving output based on the callable function corresponding to the one of the interfaces and the running user code.

### INCORPORATION BY REFERENCE

The following application hereby incorporates by reference each of the following applications filed on an even date herewith, including the application titled “Method and System for Parameter Profile Compiling” by inventor Bulent Kasman in its entirety, the application titled “Method and System for Editing Code” by inventors Bulent Kasman and Edmund dela Cruz in its entirety, and the application titled “Method and System for Dynamic Patching of Software” by inventor Bulent Kasman in its entirety.

### BACKGROUND

The ability to build, debug, and deploy software programs onto a target device is critical to software development. Debugging often involves monitoring variables, parameters, and/or resources used in a software program. One conventional method of monitoring involves inserting print statements within the program's code and performing a diagnostics session. Monitoring may also be performed during specific times of the program's execution. For example, breakpoints are often used to pause or terminate program execution, allowing the developer perform a diagnostics session in order to view the status of the variables, parameters, and resources at the specified times. However, the conventional debugging methods described above are limited. Since changes to the program code are required during debugging, the program must be recompiled and re-executed in order to view the results of these changes. Thus, the conventional debugging methods cannot be applied to programs that are currently being executed without interrupting the operation of the programs.

Additional diagnostics interactions with the program code on the target device may also be required, such as downloading patches, extracting data related to program performance and servicing, and/or collecting parameter data relating to a business operating the program. The performance of these interactions may require diagnostics data storage on the target device, thereby limiting the resource of the target device and increasing the overhead required to effectively operate the program code once deployed onto the target device.

### SUMMARY OF THE INVENTION

The present invention relates to method and system for dynamic debugging of software. According to an exemplary embodiment of the present invention, a method comprising inserting a branch instruction at an instrumentation location within a running code on a target device, the branch instruction being used execute a separately compiled instrumentation code from the running user code, exposing at least one interface corresponding to at least one callable function, and connecting the separately compiled instrumentation code to the selected at least one interface, wherein the at least one callable function executes within the separately compiled instrumentation code. According to another exemplary embodiment of the present invention, the debugging system comprises a plurality of callable functions, each callable function selectively exposing an interface, a receiving function receiving a call to one of the interfaces, wherein the call is received from a separately compiled instrumentation code being executed within a running user code a target device, and an output function receiving output based on the callable function corresponding to the one of the interfaces and the running user code

### BRIEF DESCRIPTION OF THE DRAWINGS

FIG. 1 shows an exemplary embodiment of a system for software development according to exemplary embodiments of the present invention.

FIG. 2 shows an exemplary embodiment of a system for networked software development according to exemplary embodiments of the present invention.

FIG. 3 shows an exemplary system of a debugger using the sensorpoint object code to aid in the debugging of a running application according to the present invention.

FIG. 4 shows an exemplary method for debugging the user code of the running application on a target according to exemplary embodiments of the present invention.

### DETAILED DESCRIPTION

The present invention may be further understood with reference to the following description of exemplary embodiments and the related appended drawings, wherein like elements are provided with the same reference numerals. The present invention is related to systems and methods used to develop, test and debug software. Specifically, the present invention is related to systems and methods for dynamically debugging a running application deployed on an embedded device via remote interaction. The remote interaction may be accomplished through the use of inserting software modules into running code (e.g., software application, kernel, driver, etc.) on the deployed device. For example, the software module may serve as a software patch for an application on the device, or collect data from the deployed device for predictive servicing, or extract information from the device for diagnostic or business related purposes. In addition, exemplary embodiments of the present invention may allow for the dynamic debugging to be performed by a third party programmer/developer.

According to exemplary embodiments of the present invention, dynamically debugging of the software module may allow software developers and engineers to use the software modules to aid in the monitoring of the application performance. Debugging may be defined as a methodical process of finding and reducing the number of bugs, or defects, in a computer program or a piece of electronic hardware, thereby making it behave as expected. In addition, debugging may involve identifying the circumstances in which the defect occurs, locating the source of the defect within the program, and fixing the defect.

Exemplary embodiments of the present invention provides for dynamic debugging code running on a deployed device in a field environment without shutting down or rebooting the device with instrumented software. This may be extremely useful when shutting down or rebooting the device is undesirable or even impossible. Without impacting the operating of the device, editing the code of the software module and the instrumentation locations within the source code may provide the most accurate information for diagnosing device performance and/or identifying any possible errors.

Software applications are often created on a host computing device and ported to a target device. This type of development is typical for embedded devices. An embedded device is any device that includes a processor or microcontroller that executes software to carry out desired functions. Normally, an embedded device has fewer resources than a general purpose computer, such as having a slower processor, less memory (cache, RAM, Flash, etc.), etc. Examples of embedded devices include mobile phones, personal digital assistants, smart phones, smart process monitoring devices (e.g., thermostats, pressure sensors, flow sensors, etc.), etc. The exemplary embodiments of the present invention will be described with reference to a diagnostic tool for such embedded devices. However, those skilled in the art will understand that the present invention may be implemented in, for example, a diagnostic tool for software executing on any type of device. As will be described in greater detail below, additional independent program code may be installed onto the target device in order to collect useful diagnostic information during the development of the software application. Embodiments of the present invention will be described with reference to the development of software applications for these target devices in both networked and non-networked environments.

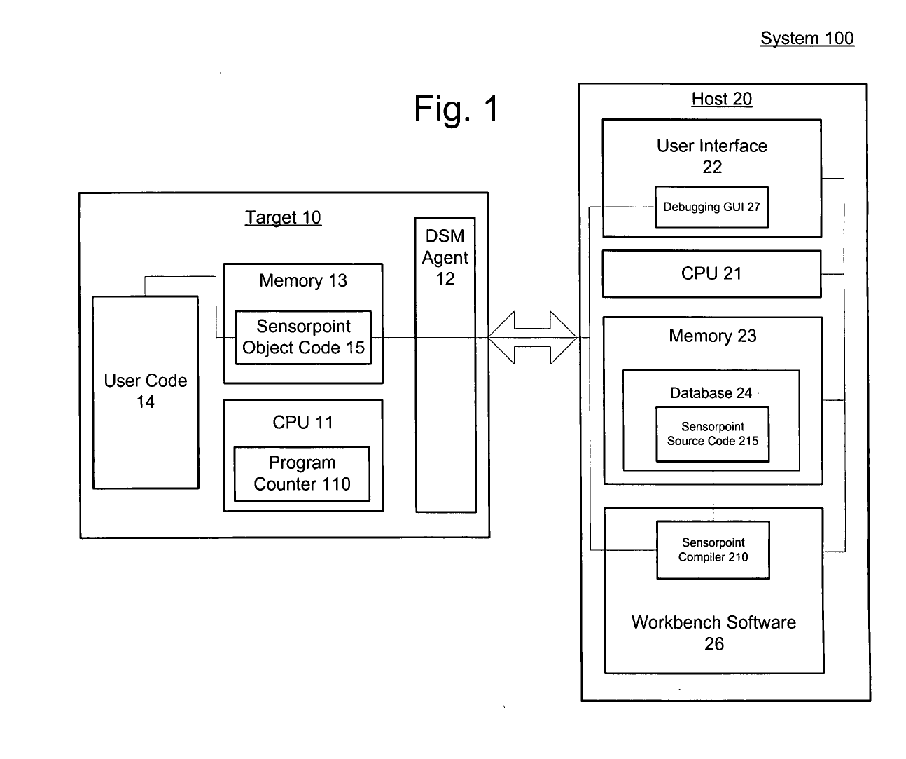

FIG. 1 shows an exemplary system 100 for integrating the editing, compiling and installing of program code within an application according to an exemplary embodiment of the present invention. The system 100 includes a target device 10 and a host device 20. In one embodiment, both the target 10 and the host 20 may be located in a lab environment, while in another embodiment, the target 10 and/or the host 20 may be in a field environment. For example, the target 10 may be deployed in a warehouse, office, etc., while the host resides in a laboratory or central server location. The host 20 may include conventional computing components such as a central processing unit (“CPU”) 21 (e.g., a microprocessor, an embedded controller, etc.) and a memory 25 (e.g., Random Access Memory, Read-only Memory, a hard disk, etc.). Likewise, the target 10 may also include a CPU 11 and a memory 13. Communication between the target 10 and the host 20 occurs over a communication link, which may be a wired (e.g., Ethernet, serial port, Universal Serial Bus, etc.) or wireless (e.g., Bluetooth, IEEE 802.1x, etc.) connection.

The host 20 may further include a user interface 22, a database 24, and workbench software 26. The user interface 22 enables a software developer to interact with the host 20 by receiving instructions and data requests. The user interface 22 may comprise any number of standard input and/or output devices, such as a keyboard (not shown), a mouse (not shown), a display 27, etc. The display 27 may provide the developer with a visual representation of programming code operating between the host 20 and the target 20. In addition, the display 27 may include a debugging graphical user interface (“GUI”) 27. The debugging GUI 27 will be described in further detail below. Throughout the description, the term developer will be used to refer to a user of the system and method disclosed herein, wherein a user may be a software engineer, a test engineer, a quality assurance engineer, support personnel, etc. Furthermore, a developer may be one or more third-party engineers, wherein the third-party engineer may build on top of the technology established by first-party developers and/or programmers.

Through the user interface 22, the developer may instruct the host 20 to transmit data to and/or from the target 10. The data may include sensorpoint modules and monitoring data. As will be discussed in detail below, sensorpoint modules comprise program code that the developer can implement on the target 10. Monitoring data may include any relevant data that the developer desires to receive from the target 10, such as device information, alarms and error messages, log information, and audit information (e.g., information related to users modifying devices and/or sensorpoint modules). The monitoring data may also relate to device type. For example, if the target 10 is a cell phone, the monitoring data may include call usage information, signal strength information, etc. The monitoring data may be transmitted automatically (e.g., at predetermined intervals) or upon request by the developer. For example, the user may request to view a log file generated by the target 10 in order to view specific program output.

The workbench software 26 is a software development tool used by the developer to create, modify, and debug software programs. The workbench software 26 may comprise a software suite that includes any number of individual software development programs, such as a compiler, a debugger, a source code analyzer, a text editor, etc. These individual programs may either be run independently of a running application or within a main development program. Using the workbench software 26, the user can create a sensorpoint module, write and edit code for the sensorpoint module, compile the code, abstract a parameter profile from the compiled code, and save the sensorpoint module to the database 24 or as a local file. Once the sensorpoint module is saved, it may be selected for transmission to the target 10. Those skilled in the art will understand that the sensorpoint code as written may not be the same as the actual code executed by the target 10. For example, the actual code may be an executable binary file created as a result of compiling and linking the sensorpoint code. The binary may be included in the sensorpoint module as an object file. In addition, the sensorpoint module may include multiple files, such as source, header and library files. These files may be installed individually or together with the entire sensorpoint module.

The database 24, or the local file system, stores sensorpoint modules, monitoring data (e.g., diagnostics logging data), and other types of data specified by the developer. The database 24 may also include user information, customer information, information regarding the target 10 (e.g., device type), parameter information regarding a business process, etc. The database 24 may be organized in any number of ways, including separate data structures for holding information corresponding to a specific target, a specific data type (e.g., sensorpoint modules), etc. The database 24 also allows for sensorpoint modules to be grouped together according to the specifications of the developer. For example, the developer may desire to group sub-components of a larger program together. The database 24 is located on writable memory 25, and may be accessed via the user interface 22.

The target 10 may further include a Device Software Management (DSM) agent 12 that may communicate with the host 20, specifically, for example, with the workbench software via the communication link. The DSM agent 12 coordinates the sending and receiving of data. Instructions and data requests are received by the DSM agent 12 and processed accordingly. When data is transmitted or received, the DSM agent 12 may first place the data into a buffer. For example, received sensorpoint modules may be temporarily stored in a buffer before writing to the memory 13 of the target 10. Likewise, data transmitted to the host 20 may first be placed in a buffer and sent when the data is ready for transmission and/or the host 20 is ready to receive the data. The DSM agent 12 may be implemented in hardware, software, or a combination thereof.

The target 10 operates using a user code 14, which comprises a program running in an operating system or a stand-alone program. The user code 14 may be written in any programming language (e.g., C/C++, Java, Assembly language, etc.). The user code 14 may be any program that the developer desires to run on the target 10. For example, the user code 14 may be a main program or subroutine being developed for implementation on the target 10. The user code 14 may include source, header, library, object, and other data files.

The target 10 may also include sensorpoint object code 15. Similar to the user code 14, the sensorpoint object code 15 may include source, header, library and object files. According to the embodiments of the present invention described herein, a sensor point is defined as a piece of code that is compiled independently of a running application (e.g., the compiled user code 14). The sensorpoint object code 15 may be executed by the running application via branch instructions inserted into the running application (e.g., the executable binary). The sensorpoint object code 15 may include keywords for logging purposes, wherein the keywords may correspond to both sensorpoint directives (e.g., sensorpoint thread) and instrumentation points identifying the locations of the user code 14. The use of the keywords for the generation of parameter profiles will be described in detail below.

Those skilled in the art will understand that the system 100 and the various components described for the host 20 and the target 10 are only exemplary and are being used to illustrate an exemplary embodiment for dynamically debugging the user code 14 running on the target 10 according to the present invention. However, dynamically debugging according to the present invention may be implemented on systems that do not include the components described herein, e.g., sensorpoints. Those skilled in the art will understand that the functionality described for dynamic debugging may be implemented on other systems that include other components. Specifically, the functionality described for the editing of sensorpoints may be performed on any independent code, wherein the independent code is compiled separately from a target code and then inserted into the target code. Such independent code may have the same characteristics as a sensorpoint (e.g., compiled code that is executed without interrupting the execution of the user code 14) or it may have different characteristics. Thus, the functionality of concern is the ability to debug software code running target 10, without shutting down or rebooting the target 10 with instrumented software.

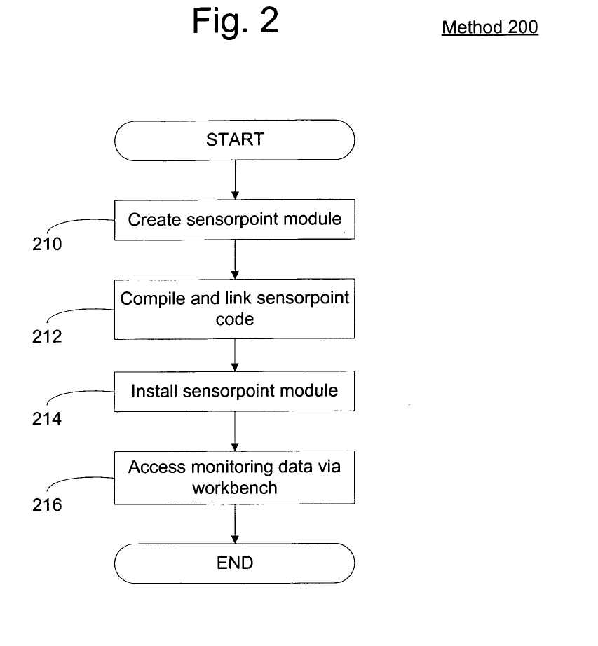

FIG. 2 shows an exemplary method 200 for software development according to the present invention that will be discussed with reference to the system 100. Beginning with step 210, a sensorpoint module is created using the workbench software 26. As previously discussed, the sensorpoint module is a software component that includes the compiled sensorpoint code and instructions relating to how the compiled sensorpoint code should be implemented. The workbench software 26 may be accessed using the user interface 22, or from the target 10 if the target 10 has its own user interface. If the sensorpoint module is a newly created module, the sensorpoint code is written, packaged within the module and stored in the database 24. Alternatively, if the sensorpoint module already exists, the existing sensorpoint code is modified and saved. The developer then specifies the user code 14 location(s) in which the branch instruction(s) should be placed.

In step 212, the sensorpoint code is compiled using the workbench software 26 and saved in the database 24 along with the rest of the sensorpoint module. The sensorpoint code is then linked. That is, the individual files (source, header, library, etc.) that comprise the sensorpoint code are combined into a single executable file (i.e., the executable binary). For example, if the programming language is C, the individual files may be placed into a User Action Library (USM) file. An exemplary sensorpoint source code 215 may be written in the C programming language, compiled and linked on the host 20, saved as a sensorpoint object code 15, and transmitted to the target 10 for execution. Branch instructions are inserted into a specific location(s) (i.e., the instrumentation points) of the user code 14 as desired by the developer, and may also be transmitted from the host 20 as part of the sensorpoint module. In other embodiments, the sensorpoint source code 215 may be written and the instrumentation points specified through a user interface located on the target 10 itself. The branch instructions may be inserted by patching the running user code 14 with precompiled branch instructions pointing to the sensorpoint object code 15. When the application reaches the instrumentation point(s), the sensorpoint object code 15 is run before execution of the user code 14 resumes. Thus, the developer may debug and develop the user code 14 without having to recompile or interrupt the execution of the user program.

In step 214, the compiled sensorpoint source code 215 is installed by transmitting the compiled sensorpoint source code 215 as sensorpoint object code 15 from the host 20 to the target 10. The DSM agent 12 receives the sensorpoint object code 15, saves it into memory allocated to the sensorpoint object code 15, processes the executable binary and updates the user code 14 with the branch instructions. During this time, the target 10 continues to execute the user code 14 and does not encounter any interruption during running of the user code 14. If the user code 14 encounters the breakpoint(s) during execution, program execution is temporarily suspended in order to allow the sensorpoint program to execute.

In step 216, the monitoring data is accessed via the workbench software 26. The developer views the monitoring data, determines whether results of the user program are as expected and, if necessary, makes changes to the sensorpoint object code 15 by repeating steps 210-216.

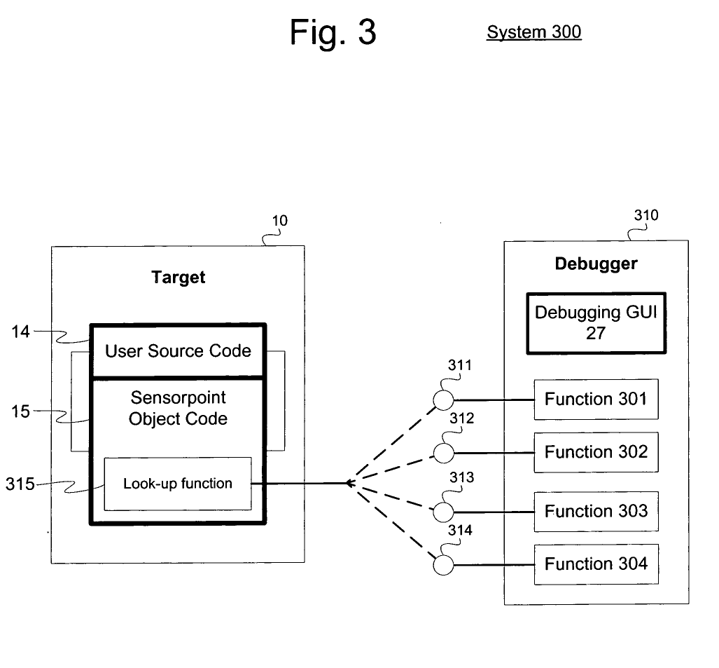

FIG. 3 shows an exemplary system 300 of a debugger 310 using the sensorpoint object code 15 to aid in the debugging of the user code 14 of the running application according to the present invention. The exemplary system 300 will be also described with reference to the exemplary system 100 of FIG. 1. The user code 14 of the running application of the target 10 may include variable names and values, as well as parameter names and values. In addition, the debugger 310 may include a number of debugging functions 301-304, wherein each function 301-304 includes an application programming interface (“API”) 311-314, respectively. Furthermore, the sensorpoint object code 15 may include a look-up function 315 for accessing the various APIs 311-314. Those skilled in the art would understand that interfaces within an application may utilize interface pointers to expose the communication boundaries between hardware and/or functions of a software program. According to exemplary embodiments of the present invention, the APIs 311-314 may be exposed to the look-up function 315 of the sensorpoint object code 15. It is important to note that while exemplary system 300 includes the functions 301-304, there may be an unlimited number of callable functions available within the sensorpoint code 15 and the developer may write custom functions to accomplish specific desired debugging tasks.

According to exemplary embodiments of the present invention, each of the APIs 311-314 may provide a basis for interoperability between the respective functions 301-304 of the debugger 310 and the sensorpoint object code 15. Therefore, once the sensorpoint object code 15 is dynamically patched into the user code 14, the debugger 310 may provide access to functions 301-304 via the APIs 311-314. The developer, either of a first-party or of a third-party, may be provided with an interface to gain access to sensorpoint object code 15 and operate the various function 301-304 of the debugger 310 within the sensorpoint object code 15. This access may allow the developer to gather information (e.g., abstract hardware and module register states) from the sensorpoint object code 15. The gathered information may then be monitored and debugged remotely by the debugger 310 of the developer in order to evaluate the performance of the sensorpoint code 15 and/or the user code 14 of the target 10.

It is important to note that while various sensorpoints may have any type of functionality, the sensorpoints, or an equivalent independently compiled code, may aid in the debugging of the running user code 14 on the target 10. Furthermore, those skilled in the art would understand that the embodiments of the present invention may be applied in various manners implementing the same functionality of debugging the running user code 14 of the target 10 with the debugger 310.

According to exemplary embodiments of the present invention, the debugger 310 may include debugging GUI 27 for the allowing the developer to interact with the sensorpoint object code 15. Specifically, the GUI 27 may allow a developer to expose one or more of the APIs 311-314 within the debugger 310 to the look-up function 315 of the sensorpoint code 15. In addition, the GUI 27 may include features such as a listing the variable names and values of functions 301-304 of the debugger 310, wherein the names and values may be selected from buttons, tabs, scroll bars, pull-down menus, etc. in order to aid the developer in the debugging process. The GUI 27 may further include various types of metadata specifications, such as timing metadata, to aid in the building of the sensorpoint object code 15 and the insertion of the sensorpoint object code 15 into the chosen instrumentation point.

It is important to note that the GUI 27 may provide the developer with multiple perspectives of one or more functions 301-304 as well as the target 10 in which the functions 301-304 operate throughout an integrated environment. In addition, multiple GUIs may be used for each of the functions 301-304. Furthermore, the GUI 27 may include visualization techniques that allow for developer input of additional data as data is needed for a particular view. This input may be accomplished by the creation and insertion of the sensorpoint object code 15, wherein the sensorpoint object code 15 acquires the needed data at the appropriate times. Thus, the data needed for the different views does not need to be collected at all times or stored when the developer is not using a particular view. The sensorpoint object code 15 allows for the developer to call the multiple views dynamically and extract the needed data from the user code 14 without the need for recompiling the code or placing an enormous amount of instrumentation within the user code 14 to provide these multiple views.

Those skilled in the art would understand that debugging GUI 27 may be displayed either on a single GUI or multiple GUIs to represent multiple user codes and multiple sensorpoint codes. Therefore, exemplary embodiment of the present invention may allow one developer, or multiple developers, to see all of the sensorpoints modules that are available within a particular operating environment. Thus, multiple developers may avoid creating duplicate sensorpoints modules, thereby enabling knowledge-based problem resolution for the developers.

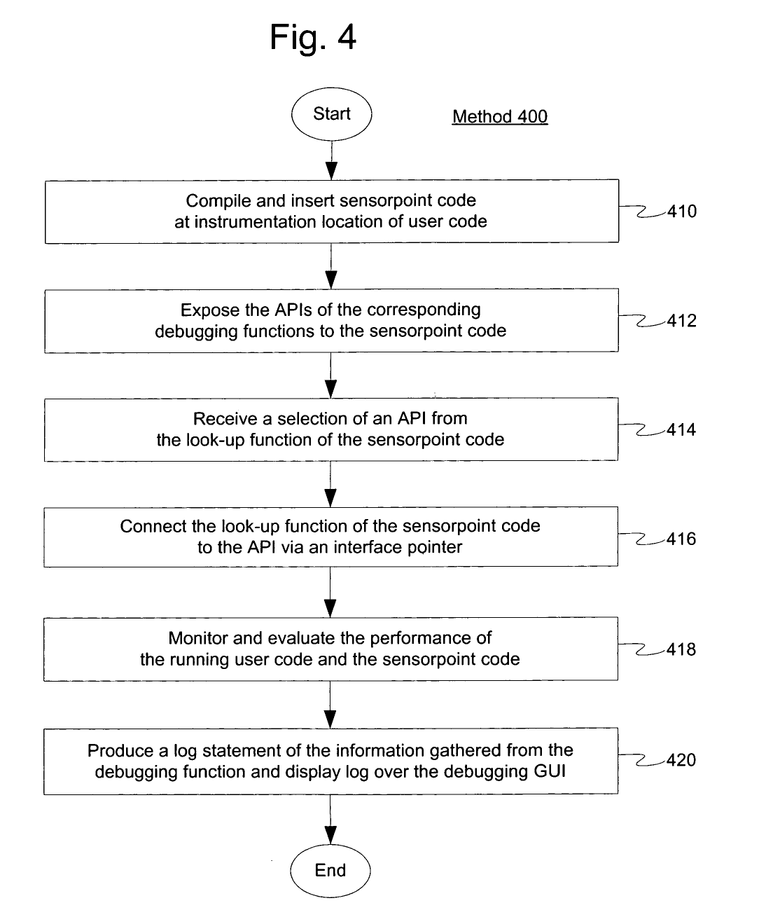

FIG. 4 shows an exemplary method 400 for debugging the running application on a target 10. The exemplary method 400 will be also described with reference to the exemplary systems 100 and 300 of FIGS. 1 and 3, respectively. According to the present invention, the method 400 may provide a developer with a dynamic debugger 310 via the sensorpoint object code 15 inserted into the user code 14. Specifically, the exemplary embodiment of the present invention provides for the placement of the sensorpoint object code 15 into a precise instrumentation point of the user code 14 running on a target 10, as well as debugging the running application through the sensorpoint object code 15 without impacting the performance of the target 10. Thus the debugging of the running application may be performed dynamically, without patching the user code 14, e.g., without coding in “printf” statements and recompiling. Thus, the running application would not have to be stopped in order to debug. It is important to note that the stopping of the running application may change the characteristics of the application timing, thereby making it difficult for the developer to debug.

In step 410, an exemplary embodiment of the present invention may, as described above, compile the sensorpoint object code 15 independently of the running application on the target 10 and may insert the sensorpoint object code 15 at a specified instrumentation location in the executable binary of the application. The sensorpoint object code 15 may be located in the target 10 in a different memory location than the location of the running application. By patching the running application with a branch instruction into the sensorpoint location, the sensorpoint object code 15 may be executed at the instrumentation point prior to returning to the remainder of the executable binary of the application.

In step 412, the exemplary system 300 may expose the APIs 311-314 of the functions 301-304 to the sensorpoint object code 15. As described above, the debugger 310 may include a number of callable functions 301-304, wherein each function 301-304 may include an API 311-314, respectively. Specifically, the system 300 may utilize the debugging GUI 27 in order to display the sensorpoint object code 15 located on a target 10. As described above, the GUI 27 may optionally provide the developer with multiple perspectives of the running application on the deployed target 10 in an integrated environment. Each of the multiple perspectives of the GUI 27 may utilize visualization techniques for the insertion of additional data, as that data is needed for a particular perspective. Therefore, the data inserted for each of the multiple perspectives may be collected and stored at different times. Thus, the views may be called dynamically by the developer, thereby allowing data to be extracted from the running application of the target 10 at anytime.

In step 414, the exemplary system 300 may receive from the look-up function 315 a selection of one of the APIs 311-314 for accessing the corresponding functions 301-304 of the debugger 310. For example, the user code 14 may relate to an application that is used for motion control of an exemplary device, wherein the user code 14 may have thousands of functions corresponding to the various movements of the device. Furthermore, the user code 14 may be dynamically patched with the sensorpoint object code 15, wherein the sensorpoint object code 15 includes the look-up function 315. The developer may utilize the debugger 310 having debugging functions 301-304 for monitoring the user code 14. According to this example, the look-up function 315 may select the API 311 for the function 301 of the sensorpoint object code 15. Specifically, the developer may desire to see if specific portions of the user code 14 are being called at the proper time. The developer may also desire to monitor the output results of the user code 14 for accuracy. Regardless of the debugging function selected, the developer may use the GUI 27 to evaluate the performance of the user code 14 and the sensorpoint code 15.

In step 416, the exemplary system 300 may connect the look-up function 315 of the sensorpoint object code 15 to the API 311 via the interface pointer. As described above, the API 311 corresponds to the debugging function 301 and may allow for the debugger 310 to be dynamically connected to the sensorpoint object code 15. In other words, API 311 may allow the developer to perform the function 301 within the user code 14 without interrupting the performance or execution of the running application on the target 10.

In step 418, the exemplary system 300 may monitor and evaluate the performance of the user code 14 and the sensorpoint object code 15. The developer may be provided with a visual representation of the performance of the user code 14 with the sensorpoint 15 via the debugging GUI 27. According to the example referred to in step 414, the developer may monitor the various motion control functions of the exemplary device. Specifically, the developer may desire to debug the portion of the user code 14 responsible for the sending of movement coordinates within the target 10. During the performance of the user code 14, the movement coordinates may be tracked and recorded by the selected debugging function 301. Those skilled in the art would understand that numerous debugging functions may be performed by the developer via the debugger 310.

In step 420, the exemplary system 300 may produce a log statement of the results and any other information gather from the debugged function 301 of the debugger 310. The log statement may be displayable to the developer via the debugging GUI 27. The log statement may include a listing of any errors in the performance and/or execution of the sensorpoint object code 15. The displayed log statement may allow the developer to debug the listed errors within the sensorpoint 15 without interfering with the running application on the target 10. The information gathered in the produced log statement may be displayed to the developer via the debugging GUI 27.

Accordingly, the developer may use exemplary method 400 to debug a portion of the user code 14 via the dynamically patched sensorpoint object code 15 as opposed to recompiling the entire user code 14. Thus, the sensorpoint module may enable the development and insertion of new instrumentation into running user code 14 of the deployed target 10 so that potential problems can be quickly identified without having to stop the running application and without recreating the potential problems in a development environment. The debugging feature of the exemplary embodiments of the present invention maybe a helpful link that enables developers to easily and accurately monitor the performance of both the sensorpoint object code 15 and user code 14 on the target 10.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
inserting a branch instruction at an instrumentation location within a running code on a target device, the branch instruction being used execute a separately compiled instrumentation code from the running user code;
exposing at least one interface corresponding to at least one callable function; and
connecting the separately compiled instrumentation code to the selected at least one interface, wherein the at least one callable function executes within the separately compiled instrumentation code.

2. The method of claim 1, wherein the at least on callable function is included in a debugger.

3. The method of claim 2, wherein the debugger comprises a display for displaying a source code corresponding to the running code on the target device.

4. The method of claim 2, further comprising:
providing the debugger with output information generated by the at least one callable function corresponding to the at least one interface.

5. The method of claim 3, wherein the display displays output information generated by the at least one callable function corresponding to the at least one interface.

6. The method of claim 1, wherein the method is performed on a host device that is remote from the target device.

7. The method of claim 1, further comprising:
executing the separately compiled instrumentation code.

8. The method of claim 7, further comprising:
returning to execute the user code after the separately compiled instrumentation code is executed.

9. The method of claim 1, wherein the separately compiled instrumentation code is a sensorpoint.

10. A debugging system, comprising:
a plurality of callable functions, each callable function selectively exposing an interface;
a receiving function receiving a call to one of the interfaces, wherein the call is received from a separately compiled instrumentation code being executed within a running user code a target device; and
an output function receiving output based on the callable function corresponding to the one of the interfaces and the running user code.

11. The debugging system of claim 10, further comprising:
a display displaying a source code corresponding to the running code on the target device and displaying output information received from the callable function corresponding to the one of the interfaces.

12. The debugging system of claim 10, wherein the system is located on a host device that is remote from the target device.

13. The debugging system of claim 10, wherein the separately compiled instrumentation code is a sensorpoint.

14. A system, comprising a memory storing a set of instructions and a processor executing the instructions, the set of instructions being operable to:
inserting a branch instruction at an instrumentation location within a running code on a target device, the branch instruction being used execute a separately compiled instrumentation code from the running user code;
exposing at least one interface corresponding to at least one callable function; and
connecting the separately compiled instrumentation code to the selected at least one interface, wherein the at least one callable function executes within the separately compiled instrumentation code.

15. The system of claim 14, wherein the at least on callable function is included in a debugger.

16. The system of claim 15 wherein the debugger comprises a display for displaying a source code corresponding to the running code on the target device.

17. The system of claim 15, further comprising:
providing the debugger with output information generated by the at least one callable function corresponding to the at least one interface.

18. The system of claim 16, wherein the display displays output information generated by the at least one callable function corresponding to the at least one interface.

19. The system of claim 14, wherein the method is performed on a host device that is remote from the target device.

20. The system of claim 14, wherein the separately compiled instrumentation code is a sensorpoint.
